(19) United States
(12) Patent Application Publication
(10) Pub. No.: US 2007/0295136 A1
(43) Pub. Date: Dec. 27, 2007

(54) Anti-backlash gear system

(75) Inventor: Matthew C. Fleming, Antioch, CA (US)

Correspondence Address: MICHAELSON & ASSOCIATES, P.O. BOX 8489, RED BANK, NJ, 07701, US

(73) Assignee: The Regents of the University of California, Oakland, CA (US)

(21) Appl. No.: 11/418,595

(22) Filed: May 5, 2006

(51) Int. Cl. F16H 55/18

(52) U.S. Cl. 74/440

(57) ABSTRACT

An anti-backlash system comprising a single drive pinion and motor is disclosed. In an exemplary embodiment, the single drive pinion is situated between two idler gears and is allowed to move in the radial direction relative to the bull gear. A preload force provides for the substantial absence of backlash at low torque loads. The pinion moves to the center point between the two idler gears and balances the torque during high torque loads. The present anti-backlash system is well suited for use in drive and positioning systems that are subject to variable and reversing loads, such as those experienced by radio telescopes in variable wind conditions.

### BACKGROUND OF THE INVENTION

1. Field of Invention

This invention relates generally to the field of gear systems and, more particularly, to a system for the reduction of backlash.

Financial support from the SETI Institute, made possible by the Paul G. Allen Foundation, is gratefully acknowledged.

2. Description of the Prior Art

Backlash in a gear system is the clearance between a gear tooth and its mating gap, or, in other words, the amount by which a gear tooth space exceeds the thickness of the engaging tooth, as measured along the pitch circle. Backlash results in a certain “looseness” in the gear train that hinders precise and repeatable indexing and/or positioning of the device or devices being driven by the gear train. When gear trains are loaded in only a single direction, backlash is typically not a concern. However, when gear trains are loaded in more than one direction of motion, for example when precise positioning and/or tracking is required as is typically the case for movable radio telescope or other receiving and/or transmitting antennas, then backlash becomes a concern.

While backlash can be reduced by using gear structures having very precise dimensional tolerances, backlash cannot be completely eliminated from any practical gear train and, indeed, it is typically not advisable to attempt to do so. Severe wear or even binding of the gear train can result when very tightly meshed gears are employed in a gear train. The backlash-inducing gap can also be useful to provide for gear lubrication as well as allowing for manufacturing and installation errors. Thus, using precise dimensional tolerances as a means to eliminate backlash is not often a practical solution. Therefore, for precise positioning, tracking or other applications in which backlash is an important concern, various devices and structures to reduce or to eliminate backlash have been proposed.

Surveys of backlash-reducing methods can be found in the article by Fredrick T. Gutmann, “18 Ways to Control Backlash in Gearing,” in Gear Design and Application, Nicholas P. Chironis Ed. (McGraw-Hill, 1967), pp. 237-242, and also at the website http://www.sdp-si.com.

The practical need for reducing or eliminating backlash in precise positioning or indexing systems has led to several approaches disclosed in U.S. patents. For example, we note the following: Hannel (U.S. Pat. Nos. 4,747,321; 4,805,475). Vranish (U.S. Pat. Nos. 5,409,431; 5,540,630). Rothstein et al. (U.S. Pat. No. 5,729,100). Genter et al. (U.S. Pat. No. 5,870,928). Shook et al. (U.S. Pat. No. 5,979,259). Long et al. (U.S. Pat. Nos. 5,979,260; 6,247,377). Mauro (U.S. Pat. No. 6,016,716). Gardiner (U.S. Pat. No. 6,148,684). Wood (U.S. Pat. No. 4,554,842). Atobe (U.S. Pat. No. 4,549,703). Sauter (U.S. Pat. No. 4,189,951). Bodnar (U.S. Pat. No. 4,036,074). Ring et al. (U.S. Pat. No. 6,419,061). Kiunke (U.S. Pat. No. 4,305,307). And also the following exemplary published patent applications: Huang (2003/0101834 A1). Johnson et al. (2003/0140719 A1). And Stevens et al. (2004/0089089 A1).

Backlash can be a particularly challenging problem when the positioning system experiences reversing and variable loads such as positioning a radio telescope, dish antenna and the like that may be subject to variable and shifting wind loading. A typical solution is to employ an anti-backlash system causing the gears always to stay loaded in the same direction. For example, an anti-backlash system may use two sets of gears working in opposition to remove backlash. This is frequently done by means of a spring element forcing gears in opposite directions. However, only one set of gears is available to carry the load while the second set of gears only provides anti-backlash. If extreme loads are experienced or anticipated, only one set of gears is available to bear such load. Therefore, when the direction of an extreme load is unpredictable, such as wind loading of a radio telescope, both sets of gears must be designed with maximal loading in view.

Many radio telescope systems employ two separate motor and drive systems that act on a main bull gear. During precision operation, the two drives oppose each other, thereby removing backlash. During high torque operation, the two motor and drive systems operate in parallel, causing all gears to function at or near full capacity. However, this system has the disadvantage of requiring two motor and drive systems.

Thus, a need exists in the art for an anti-backlash system capable of precise positioning under conditions of variable and unpredictable loading while employing only a single drive pinion and motor and employing other gear components with increased efficiency.

### SUMMARY OF THE INVENTION

Accordingly and advantageously the present invention includes an anti-backlash system comprising a single drive pinion and motor, wherein the drive pinion is movably mounted between two idler gears. Under low torque operation, the pinion is moved radially to remove backlash. During high torque operation, the pinion becomes centered substantially midway between the idler gears, advantageously centered as close as is feasible to the line joining the centers of the idler gears. Such a central position for the pinion gear facilitates load sharing among the pinion and idler gears.

The anti-backlash system of the present invention is well suited for use in drive and positioning systems that are subject to reversing and variable loads such as those experienced by radio telescopes in variable wind conditions. Other possible applications include rotary tables, turrets, cranes, manlifts, as well as other positioning systems and devices as will be apparent from the following description to those having ordinary skills in the art.

These and other advantages are achieved in accordance with the present invention as described in detail below.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not to scale.

The techniques of the present invention can readily be understood by considering the following detailed description in conjunction with the accompanying drawings, in which:

FIG. 1 depicts a partial perspective view of a bull gear, pinion gear and two idler gears.

FIG. 2 depicts a top perspective view of the anti-backlash system pursuant to some embodiments of the present invention.

FIG. 3 depicts a perspective view of the anti-backlash system pursuant to some embodiments of the present invention indicating the direction of spring loading for the pinion gear and a typical configuration for the pivot pin.

FIG. 4 depicts a top cut-away view of the anti-backlash system pursuant to some embodiments of the present invention depicting the direction of motion of the pivot gear “Pull,” a fixed pinion pivot pin and fixed pins for the idler gears, as functioning in the anti-backlash mode.

FIG. 5 depicts a top cut-away view of the anti-backlash system pursuant to some embodiments of the present invention depicting the direction of motion of the pivot gear “Pull,” a fixed pinion pivot pin and fixed pins for the idler gears, as functioning in the high capacity mode.

FIG. 6 depicts an illustration of the anti-backlash system pursuant to some embodiments of the present invention depicting the application to a drive train comprising a multi-level gear reduction system.

FIG. 7 AND FIG. 8 depict in perspective view examples of hinge mountings for the movable pinion gear.

### DETAILED DESCRIPTION OF THE INVENTION

After considering the following description, those skilled in the art will clearly realize that the teachings of the invention can be readily utilized as an anti-backlash system in mechanical positioning systems such as radio telescopes among others.

In typical gear drive systems, it is advantageous in most applications for a small gap to be present between the teeth of any two meshing gears. Such a gap allows for manufacturing and installation tolerances as well as to facilitate lubrication. This gap can be reduced for very high precision parts, but severe wear can result if the gap is completely eliminated as the gear teeth are wedged into each other. This gap is called “backlash” and results in a certain “looseness” in the gear drive system that is particularly apparent when reversing direction of motion.

In power transmission systems, the gear teeth typically apply a force in only one circumferential direction so backlash is generally not a serious concern. The situation is different, however, in gear-driven positioning systems in which forces are applied sequentially in both directions as the final position is sought and obtained. In such circumstances, backlash can be a serious concern. For example, if the positioning system experiences reversing loads, such as wind loading of dish-type radio telescopes, gear backlash can limit positioning accuracy.

One approach to overcoming backlash-limited positioning accuracy is to employ an anti-backlash system such that the gear teeth always experience a load (apply a force) in the same direction. A typical anti-backlash system uses two sets of gears working in opposition to each other such that backlash is removed. This is often done by means of a spring element that forces the gears in opposite rotations. However, under conditions in which large loads are experienced, this approach to anti-backlash has only one set of gears carrying the load while the other set of gears merely provides anti-backlash. For example, in many radio telescope systems, two separate motor and drive systems operate on a main bull gear. During high torque (high loading) operation, the two drive systems operate in parallel so that all gears function at full capacity. During precision operation, the drives oppose each other to remove backlash.

The present invention provides anti-backlash while using a single drive pinion and motor, thereby making more efficient use of various gear and system components.

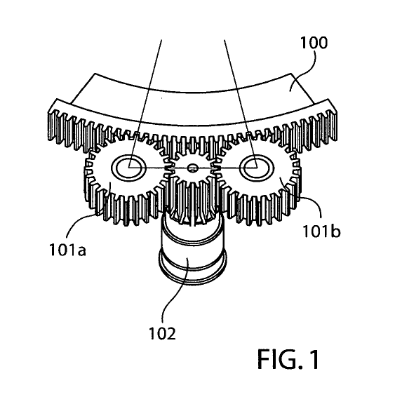

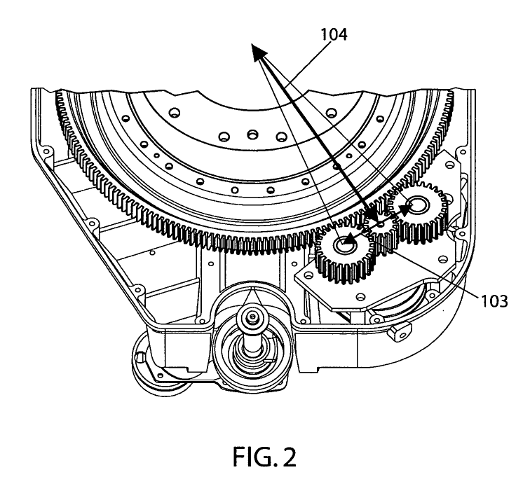

Referring now to FIG. 1, the anti-backlash reduction gearing pursuant to some embodiments of the present invention includes one large bull gear, 100, two substantially identical idler gears, 101a, 101b, and a single drive pinion, 102. The idler gears engage the outside edge of the bull gear and are spaced a distance apart, denoted as 103 in FIG. 2. The pinion gear is typically positioned between the idler gears with such clearances as are customarily employed. That is, precise tolerances are not required. It is advantageous in some embodiments of the present invention that the gear sizes be chosen so that the center of the pinion can be positioned on the line connecting the centers of the idler gears, as depicted in FIG. 1. The two idler gears, 101a and 101b, are typically mounted on fixed pins while the pinion gear, 102, is free to move radially in or out from the bull gear, that is substantially along the direction indicated by 104 in FIG. 2.

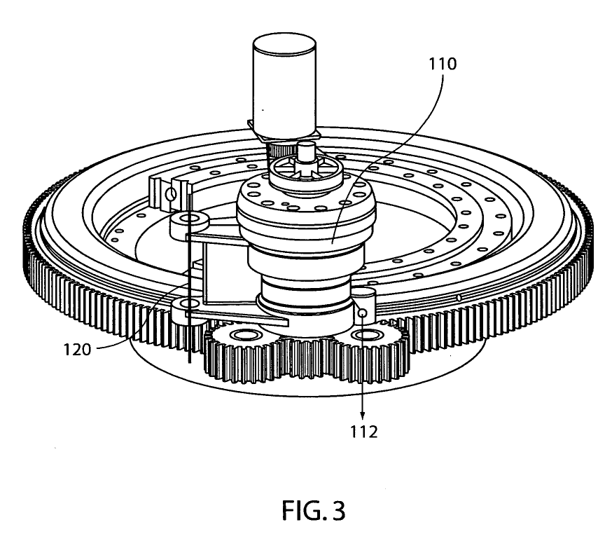

During low torque operation, the pinion is pulled or pushed radially, thereby removing backlash. As torque loading increases, the pinion overcomes the radial preload and centers itself between the idler gears. This central position allows load sharing across the teeth of the pinion and among the two idler gears. At very high torque loadings, the dominant reaction is basically pure torque loading on the pinion and on the gearbox, 110 as shown for an exemplary embodiment in FIG. 3.

The behavior just described is found to function advantageously for certain gear sizes. For example, in one embodiment, a reduction of 12.86 is achieved with a 6 pitch bull gear of 180 teeth, idler gears of 25 teeth and a pinion with 14 teeth. Another embodiment uses a 12 pitch bull gear of 144 teeth, idler gears of 21 teeth and a pinion with 12 teeth.

The two idler gears typically use needle bearings running on hardened pins. The pins are advantageously anchored at both the top and bottom to minimize deflections. These pins are typically the primary path for delivering the tangential drive force to the structure.

Continuing to refer to FIG. 3, in this embodiment the pinion gear and its reducing gear box are supported on a fixed vertical pivot pin, 120. This maintains a rigid position for proper pinion to idler gear clearance and allows the pinion to swing radially outward to eliminate backlash. The vertical pivot pin 120 is anchored top and bottom and takes the primarily torque loads in this embodiment. Another advantage of this structure is the relatively easy removal of the pinion and reducer gearbox assembly 110 by disconnecting the spring load 112 and pulling the pivot pin 120.

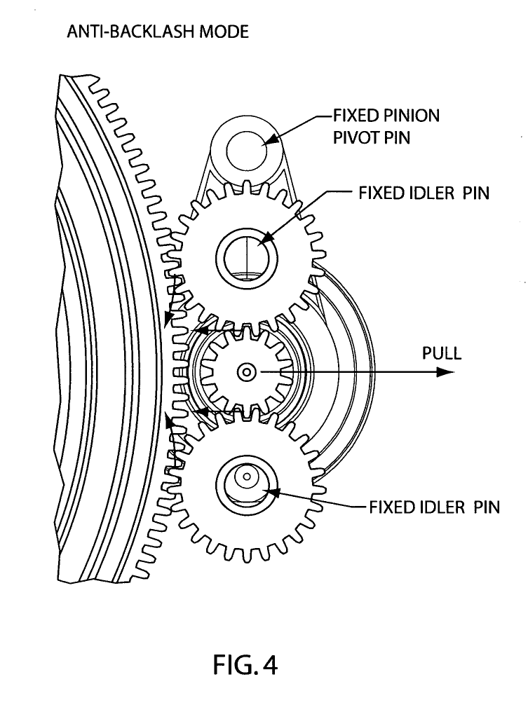

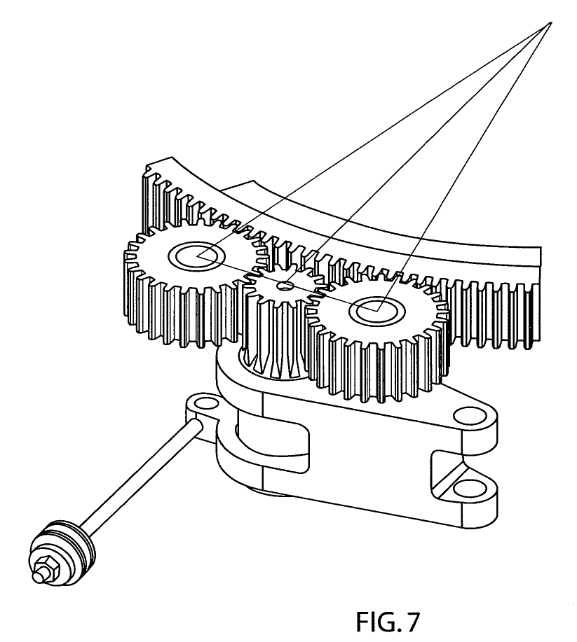

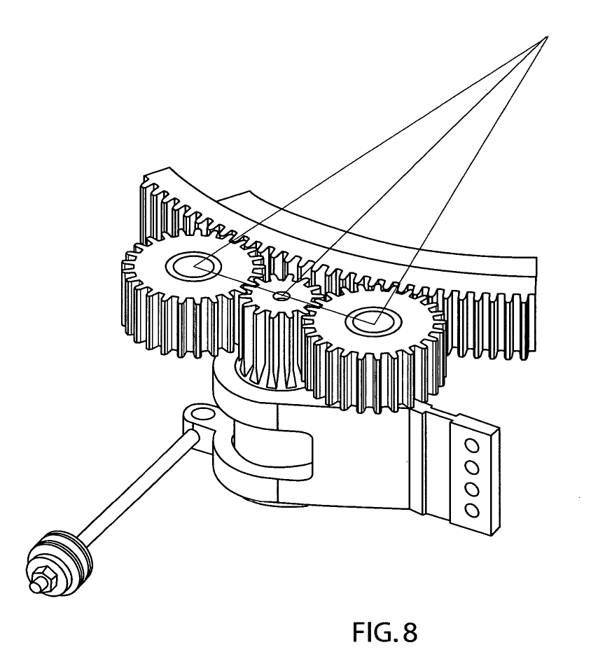

The required preload or pull exerted on the pinion gear box can be applied by a flexible mount, coil spring, Belleville spring, air cylinder or some other similar device. The movement required is typically quite small. In this design the pinion gearbox pivots on a fixed vertical pin that only allows radial anti-backlash movement and removes all backlash from the gear seats. This is illustrated in FIG. 4. The pinion position and radial movement could also be controlled with a slide way or slots. Examples of hinge mountings for the pinion gear are depicted in FIG. 7 and FIG. 8.

While torque requirements are low, the pinion is able to turn slowly, positioning the system while backlash is removed by the preload spring. This is particularly advantageous for telescope fine positioning in low wind conditions. Radial clearance in the pinion shaft bearings and pivot pin bearings is present but reduced by the side loading from the preload spring system.

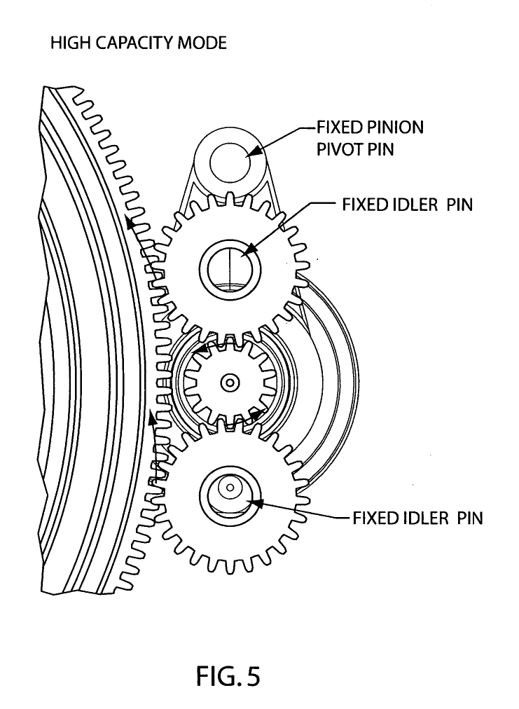

When torque loads increase to a certain point, the pinion will overcome the preload and move slightly inward. In this position, the pinion begins to act to share torque in the same direction across both idler gears. As torque requirements increase, the loads on the pinion become nearly balanced. During very heavy torque loading, the cantilevered pinion is well supported by both idler gears and has no tendency to bend away from the mating gears. This is illustrated in FIG. 5 where the load is balanced across both idler gears and they work in cooperation. This design is particularly advantageous for telescopes where extra capacity is needed for drive to stow and for high wind survival.

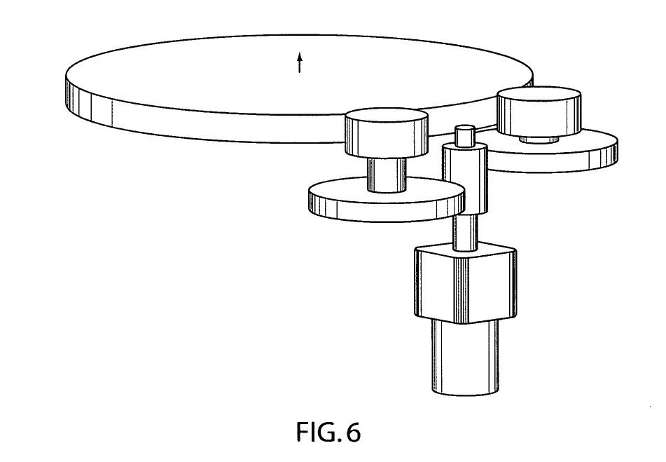

In another embodiment of the present invention, the anti-backlash system as described above is incorporated into a multi-gear drive train. The discussion above addressed a single level of gear reduction. FIG. 6 illustrates how the present invention may typically be applied to a gear drive system that comprises several levels of gear reduction. It is clear that the anti-backlash principles remain the same and the configuration illustrated in FIG. 6 would function well for accurate positioning without substantial backlash-induced errors.

Some of the embodiments of the present invention include a means for preloading the pinion gear as described elsewhere herein. However, advantages also arise in the structure and operation of a gear system having a pinion gear movable in the radial direction (with respect to the bull gear) but without preloading, that is, a movable pinion gear substantially as described elsewhere herein but lacking preloading. For economy of language, we denote such embodiments that lack any form of preloading as “springless.”

While a springless gear system is expected to lack some of the favorable anti-backlash properties of preloaded embodiments, other advantages accrue. For example, in many high-reduction gear systems, a limit on the performance of the gear system arises from the limited bending strength and from deflection of the pinion. This limit arising from stress and deflection of the pinion becomes particularly apparent if the pinion is small in diameter (with respect to the bull gear) so as to achieve a high ratio with a single gear stage. With adjacent idler gears as described herein, the pinion is restrained from bending and tooth loading becomes quite uniform. The result is typically that higher loads can be transmitted through a gear system employing less material, a clear economic benefit and particularly advantageous in systems in which the gear system is a part of the mass to be moved and precisely positioned, such as a dish-type radio telescope.

Although various embodiments which incorporate the teachings of the present invention have been shown and described in detail herein, those skilled in the art can readily devise many other varied embodiments that still incorporate these teachings.

What is claimed is:

1. An anti-backlash system comprising:
a drive pinion gear engaging a first idler gear and a second idler gear, wherein said first idler gear and said second idler gear have substantially the same shape and are mounted on fixed axes;
a bull gear engaging said first idler gear and said second idler gear, wherein said drive pinion gear is movably mounted so as to move radially in the direction of said bull gear; and,
wherein said drive pinion gear is preloaded in said radial direction.

2. An anti-backlash system as in claim 1 wherein said drive pinion gear is movably mounted with its axis substantially midway between the axes of said first idler gear and said second idler gear.

3. An anti-backlash system as in claim 1 wherein said bull gear is 6 pitch with 14 teeth, said first and said second idler gears each have 25 teeth and said pinion gear has 14 teeth, thereby achieving a 12.86 reduction.

4. An anti-backlash system as in claim 1 wherein said bull gear is 12 pitch with 144 teeth, said first and said second idler gears each have 21 teeth and said pinion gear has 12 teeth.

5. A gear system comprising:
a drive pinion gear engaging a first idler gear and a second idler gear, wherein said first idler gear and said second idler gear have substantially the same shape and are mounted on fixed axes; and,
a bull gear engaging said first idler gear and said second idler gear, wherein said drive pinion gear is movably mounted so as to move radially in the direction of said bull gear.
